(19) United States
(12) Patent Application Publication
(10) Pub. No.: US 2010/0122233 A1
(43) Pub. Date: May 13, 2010

(54) SOFTWARE LICENSE INDEPENDENT MODEL IMAGE GENERATION SYSTEM AND METHOD

(75) Inventors: Manaswini Rath, Bangalore (IN); Badari Kotejoshyer, Bangalore (IN); Yogananda Vasudev Jeppu, Bangalore (IN)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 12/270,412

(22) Filed: Nov. 13, 2008

(51) Int. Cl. G06F 9/44

(52) U.S. Cl. 717/105

(57) ABSTRACT

A system and method for generating an image of a software model that was generated using proprietary, licensed software, and that comprises one or more components defined by descriptive data. The generated software model is received and parsing the descriptive data representative of each component. A software license independent image of the one or more components is generated using the parsed descriptive data, and a software license independent image of the generated software model is generated using each of the generated software license independent images. The system and method may also be used to generate dataflow diagrams and signal lists.

### TECHNICAL FIELD

The present invention generally relates to model-based design systems and methods and, more particularly to a system and method for generating software license independent images of software models generated using proprietary, licensed software.

### BACKGROUND

There is an ever-increasing demand for quick time-to-market and diverse functionalities for many vehicular products in the aircraft, watercraft, and automobile industries. As such, the traditional development process has, in many instances, been replaced with a model-based development process. When implementing this process, which is oftentimes referred to as “Model Based Development” (MBD), a designer typically develops one or more software models that simulate the functionality of a new product. Typically, the software models that are developed as part of a MBD process are generated using proprietary software tools, such as Simulink®, that were developed for such tasks.

In many industries, both system and safety analyses may be conducted on the models that are developed as part of a MBD. To conduct these analyses, an analyst need not to execute the software model, but only browse through the software model subsystems and components to gain an understanding of the design. However, a user is generally required to have an appropriate software license even to just browse inside software model subsystems and components. Obtaining software licenses for this task can be relatively expensive, driving up overall design, development, and analysis costs.

In addition to the above, some portions of the analyses are presently conducted manually. These portions include the creation of one or more dataflow diagrams of the software model, and the creation of signal lists. The dataflow diagrams depict, in a manner similar to a high-level functional block diagram, a single view of the complete design. The signal lists and enable signal traceability through the model. While very effective, these portions of the analyses can be relatively cumbersome, time-consuming, and costly.

Hence, there is a need for a platform independent system and method that can generate and display appropriate images of a software model design that was created using licensed, proprietary software and that also generates various other analysis support artifacts, such as dataflow diagrams and signal lists. The present invention addresses at least this need

### BRIEF SUMMARY

In one embodiment, and by way of example only, a method of generating an image of a software model that was generated using proprietary, licensed software, and that comprises one or more components defined by descriptive data, includes the steps of receiving the generated software model and parsing the descriptive data representative of each component. A software license independent image of the one or more components is generated using the parsed descriptive data, and a software license independent image of the generated software model is generated using each of the generated software license independent images.

In yet another exemplary embodiment, a method of generating an image of a data flow diagram for a software model that was generated using proprietary, licensed software, and that comprises one or more components defined by descriptive data, includes the steps of generating a library of functional blocks that each define a high-level function, where each functional block comprises one or more components with defined connectivity. The generated software model is received, and the descriptive data representative of each component is parsed to determine interconnections thereof. A determination is made as to whether at least selected ones of the components of the generated software model, when grouped together, match one the functional blocks in the library, and those components of the generated software model that match the functional blocks are grouped into the matched functional block. An image of the generated software model is render on a display device using the matched functional blocks and the determined interconnections.

In still another exemplary embodiment, a system for generating a software license independent image of a software model that was generated using proprietary, licensed software, and that comprises one or more components defined by descriptive data, includes a display device and a processing system. The processing system is in operable communication with the display device, and is configured to selectively import the generated software model and to (i) parse the descriptive data representative of each component, (ii) generate data representative of a software license independent image of the one or more components using the parsed descriptive data, and (iii) using the generated data, command the display device to render a software license independent image of the generated software model.

Other desirable features and characteristics of the present invention will become apparent from the subsequent detailed description and the appended claims, taken in conjunction with the accompanying drawings and the preceding background.

### BRIEF DESCRIPTION OF THE DRAWINGS

The present invention will hereinafter be described in conjunction with the following drawing figures, wherein like numerals denote like elements, and wherein:

FIG. 1 depicts a functional block diagram of an exemplary system that may be used to implement various processes described herein;

FIG.2 depicts an exemplary software model that may be retrieved by the system of FIG. 1 for use by the various processes described herein;

FIGS. 3 and 4 depict a process that is implemented in the system of FIG. 1 to display a software license independent image of the software model of FIG. 2;

FIGS. 5 and 6 depict a process that is implemented in the system of FIG. 1 to generate and render a dataflow diagram for a software model;

FIG. 7 depicts an illustrative example of part of the process depicted in FIGS. 5; and

FIGS. 8 and 9 depict a process that is implemented in the system of FIG. 1 to generate a signal list for a software model.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

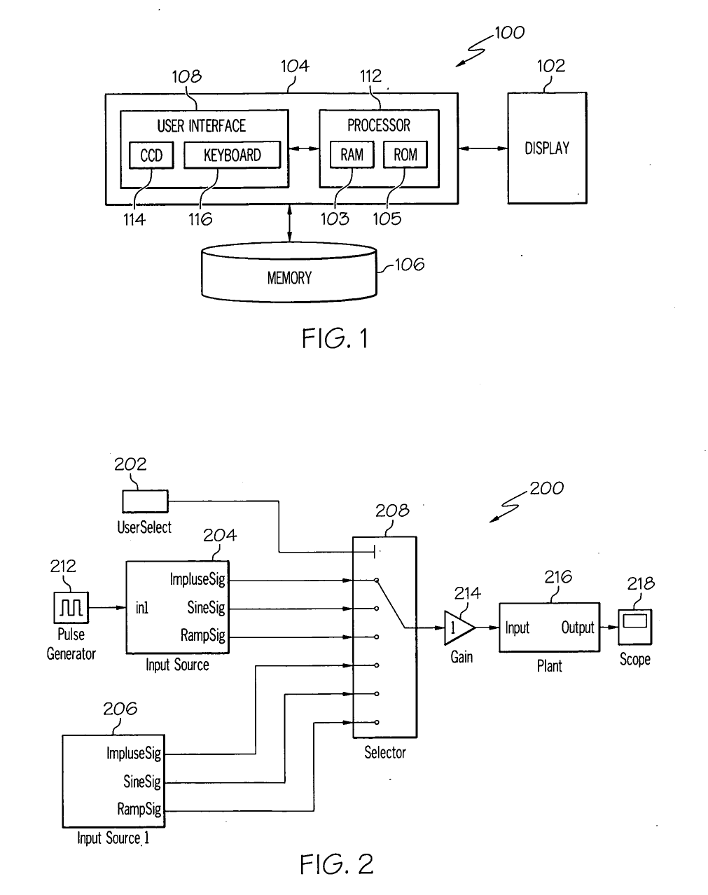

Referring first to FIG. 1, a functional block diagram of an exemplary system 100 that may be used to implement the processes described herein is depicted. In the depicted embodiment, the system 100 includes a display device 102, a processing system 104, and memory 106. The display device 102 is in operable communication with the processing system 104 and, in response to display commands received therefrom, displays various images. It will be appreciated that the display device 102 may be any one of numerous known displays suitable for rendering graphic, icon, and/or textual images in a format viewable by a user. Non-limiting examples of such displays include various cathode ray tube (CRT) displays, and various flat panel displays such as, for example, various types of LCD (liquid crystal display) and TFT (thin film transistor) displays. The display device 102 may additionally be based on a panel mounted display, a head up display (HUD) projection, or any known technology.

The processing system 104, at least in the depicted embodiment, includes a user interface 108 and a processor 112. The user interface 108 is in operable communication with the processor 112 and is configured to receive input from a user and, in response to the user input, supply various signals to the processor 112. The user interface 108 may be any one, or combination, of various known user interface devices including, but not limited to, a cursor control device (CCD), such as a mouse, a trackball, or joystick, and/or a keyboard, one or more buttons, switches, or knobs. In the depicted embodiment, the user interface 108 includes a CCD 114 and a keyboard 116. A user may use the CCD 114 to, among other things, move a cursor symbol over, and select, various items rendered on the display device 102, and may use the keyboard 116 to, among other things, input various data. A more detailed description of the why a user may select various rendered items with the CCD 114, and the various data that a user may input is provided further below.

The processor 112 is in operable communication with the memory 106, the display device 102, and the user interface 108 via one or more non-illustrated cables and/or busses. The processor 112 is configured to be responsive to user input supplied to the user interface 108 to, among other things, selectively retrieve data from memory 106, and to command the display device 102 to render various graphical, icon, and/or textual images. The processor 112 may include one or more microprocessors, each of which may be any one of numerous known general-purpose microprocessors or application specific processors that operate in response to program instructions. In the depicted embodiment, the processor 112 includes on-board RAM (random access memory) 103 and on-board ROM (read only memory) 105. The program instructions that control the processor 112 may be stored in either or both the RAM 103 and the ROM 105, or on a non-illustrated local hard drive. It will be appreciated that this is merely exemplary of one scheme for storing operating system software and software routines, and that various other storage schemes may be implemented. It will also be appreciated that the processor 112 may be implemented using various other circuits, not just one or more programmable processors. For example, digital logic circuits and analog signal processing circuits could also be used.

The memory 106, as noted above, is in operable communication with the processor 112. The memory 106 has various data stored thereon. These data include one or more software models that were generated using proprietary, licensed software. For example, the memory 106 may have one or more Simulink® models stored thereon. These data also include library data, which are representative of functional blocks that define various high-level functions. The purpose of these latter data will become apparent further below. It will be appreciated that the memory 106 may be implemented using any one or more of numerous suitable devices for receiving and storing software models and the library. Some non-limiting examples include static memory, magnetic disks, hard drives, floppy drives, thumb drives, compact disks, and the like. In addition, the software models and the library may, if needed or desired, be stored on separate memory devices or in separate sections of a common memory device. Moreover, the memory 106 may be disposed within the same structural casing as the processing system 104 and/or display device 102, or it may be disposed separately therefrom. It will additionally be appreciated that the processor 112 and memory 106 may be in operable communication via a local wired or wireless local area network connection or via a wide area network connection.

No matter the specific manner in which the display 102, the processing system 104, and memory 106 are implemented and in operable communication, the processing system 104 is configured, generally in response to one or more user inputs to the user interface 108, to retrieve a software model from the memory 106. The processing system 104, implementing various software algorithms (e.g., processes), generates various platform independent images and data associated with the retrieved software model. These various algorithms will now be described. Before doing so, however, it is noted that the term “software license independent” as used herein means independent of the proprietary, licensed software that generated the retrieved software model.

To facilitate the description of the first process to be described, the exemplary software model depicted in FIG. 2 will be used. The depicted model 200 includes a user select function 202, a first input source 204, and a second input source 206 all coupled to separate inputs of a selector 208. A pulse generator 212 is coupled to an input of the first input source 204, and the output of the selector 208 is coupled to a gain 214. The gain 124 is in turn coupled to a masked subsystem (e.g., a plant) 216, the output of which is supplied to a scope (or observer) 218. An understanding of the depicted model 200, and of the individual components, devices, and subsystems that comprise the model 200, is not needed and therefore will not be provided. It will be appreciated that each of the blocks depicted in FIG. 2 may comprise a plurality of individual, non-illustrated components.

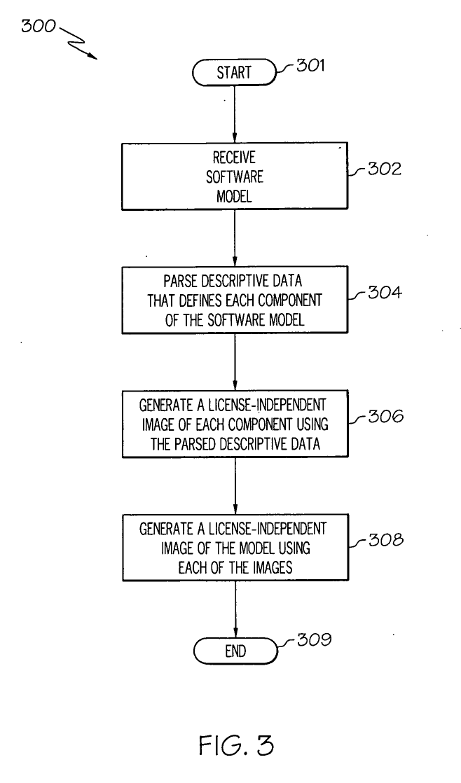

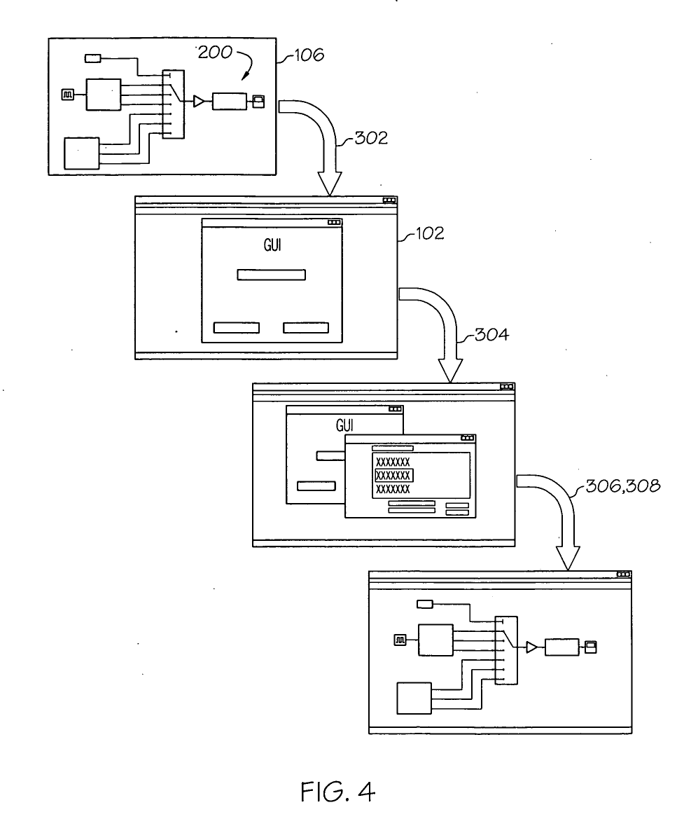

Turning now to FIGS. 3 and 4, a process 300 that is used to display a platform independent image of a software model, such as the one depicted in FIG. 2, will now be described. As FIGS. 3 and 4 depict, the processing system 104, in response to user input to a graphical user interface (GUI) rendered on the display device 102, retrieves the software model 200 from, for example, the memory 106 (302). The processing system 104 then parses the descriptive data that defines each component of the software model 200 (304). As is generally known, the components of a software model, such as the depicted model 200, are defined by descriptive data. These descriptive data may include, for example, data representative of graphical representation, component function, input and output connections, component specific parameters, etc. It is these data that the processing system 104 parses.

The processing system 104, using the parsed descriptive data, generates a platform independent image of each component that comprises the software model 200 (306). Thereafter, a platform independent image of the entire model 200 is generated using each of the generated component images (308). The image may be generated in any one of numerous common formats including, for example, HTML. PDF, or JPG formats. As FIG. 4 depicts more clearly, the processing system 104 may, either automatically or in response to user input, command the display device 102 to render the software license independent image 400 of the generated software model 200. Although not depicted, it is noted that a user may, using for example the CCD 118, select one or more of the blocks of the software license independent image 400 that is rendered on the display device 102 to view one or more of the individual components or subsystems that comprise the selected block. These individual components or subsystems will, as may be appreciated, also be rendered as software license independent images.

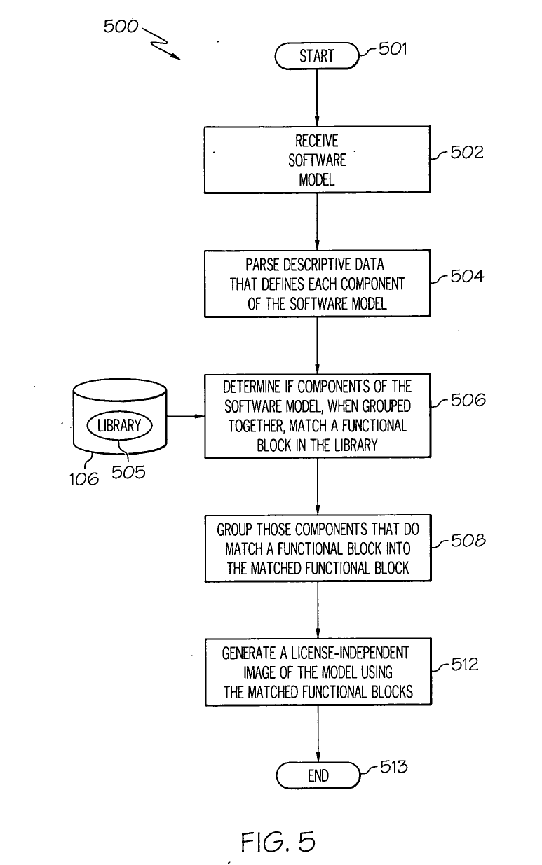

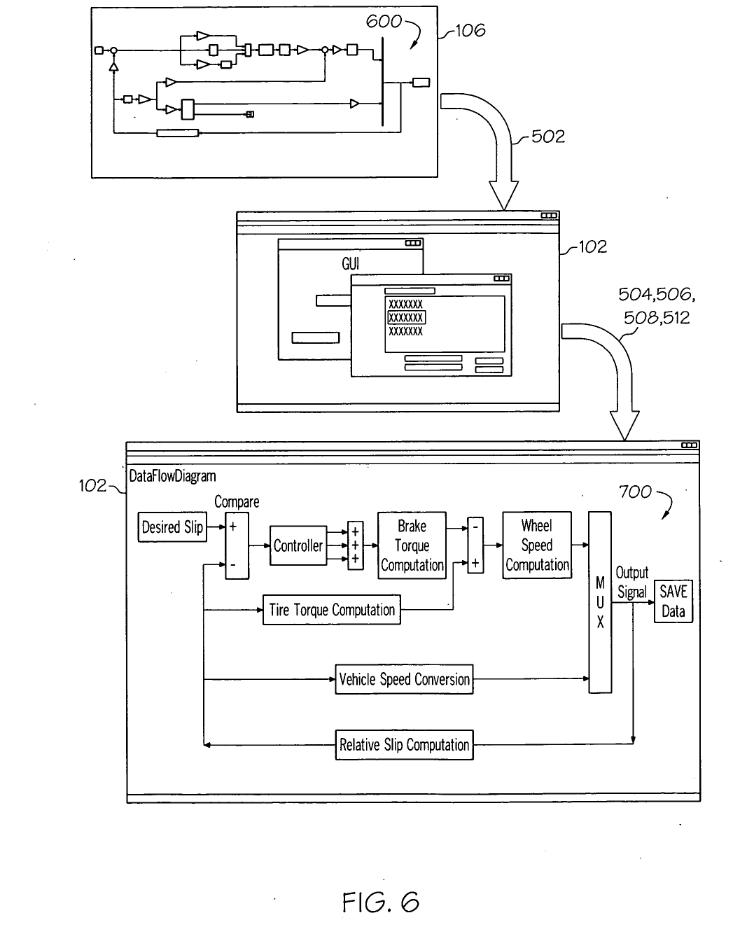

In addition to generating and render software license independent images of the software model, as described above, the system 100 may also implement a process to generate and render one or more data flow diagrams for a software model that was generated using proprietary, licensed software. This process, which is depicted in FIGS. 5 and 6, will now be described. As with the previous process 300, the processing system 104, in response to user input to a graphical user interface (GUI) rendered on the display device 102, retrieves the software model 600 from, for example, the memory 106 (502), and parses the descriptive data that defines each component of the software model 600 (504).

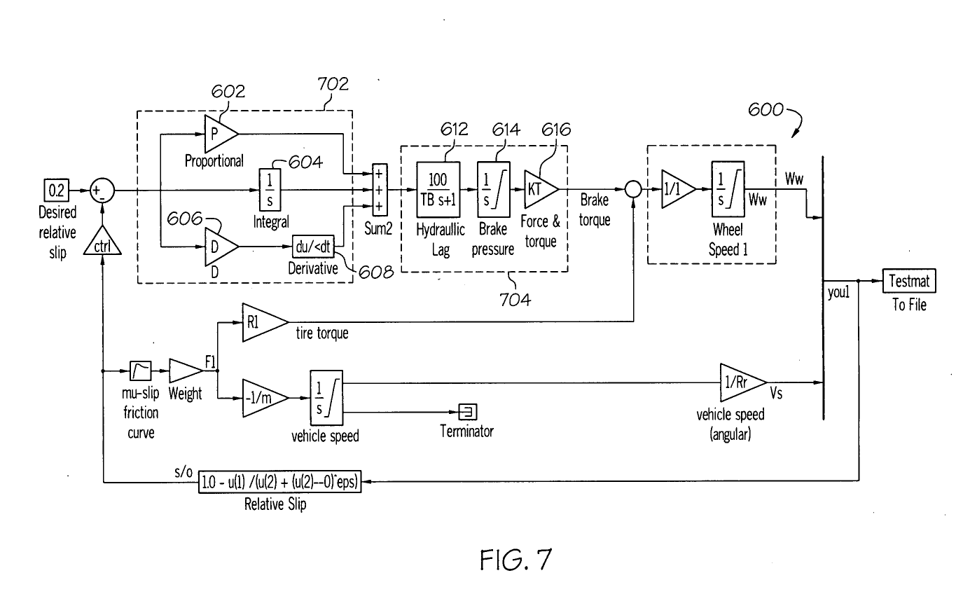

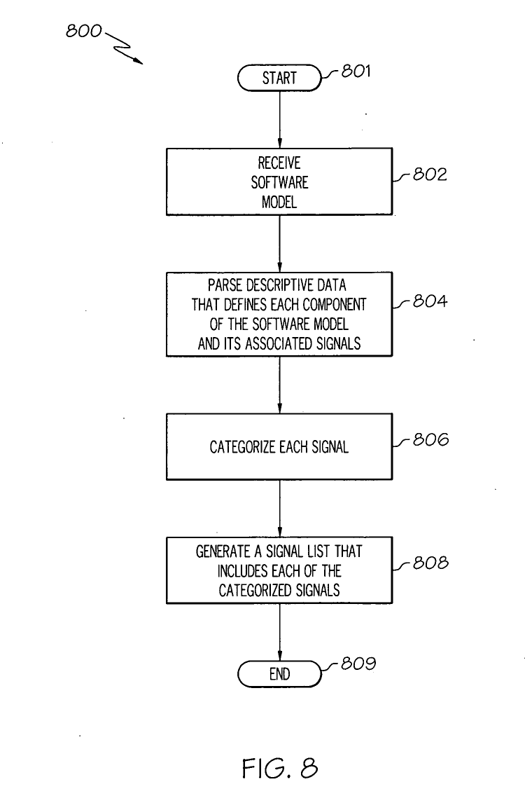

Using the parsed descriptive data and the library data (505), the processing system 104 determines whether at least selected ones of the components of the generated software model 500, when grouped together, match one the functional blocks in the library data (506). The processing system 104 then groups those components of the generated software model 500 that do match a functional block into the matched functional block (508). As an illustrative example of part of the process 500, reference should be made to FIG. 7 in which it is seen that, for the depicted software model 600, the processing system 104 determined that those components surrounded by dotted lines matched a functional block in the library data (505) and grouped these components together. For example, it is seen that the proportional gain 602, the integrator 604, and the series-coupled gain 606 and derivative 608 match a controller functional block 702 in the library data (505), that the lag filter 612, integrator 614, and gain 616 match a brake torque computation block 704, and so on.

Returning once again to FIG. 5, after the previous determinations are made, a software license independent image of a dataflow diagram 700 is generated using the matched functional blocks and the determined interconnections (512). As FIG. 6 depicts, the processing system 104 may, either automatically or in response to user input, command the display device 102 to render the software license independent image 700 of the dataflow diagram.

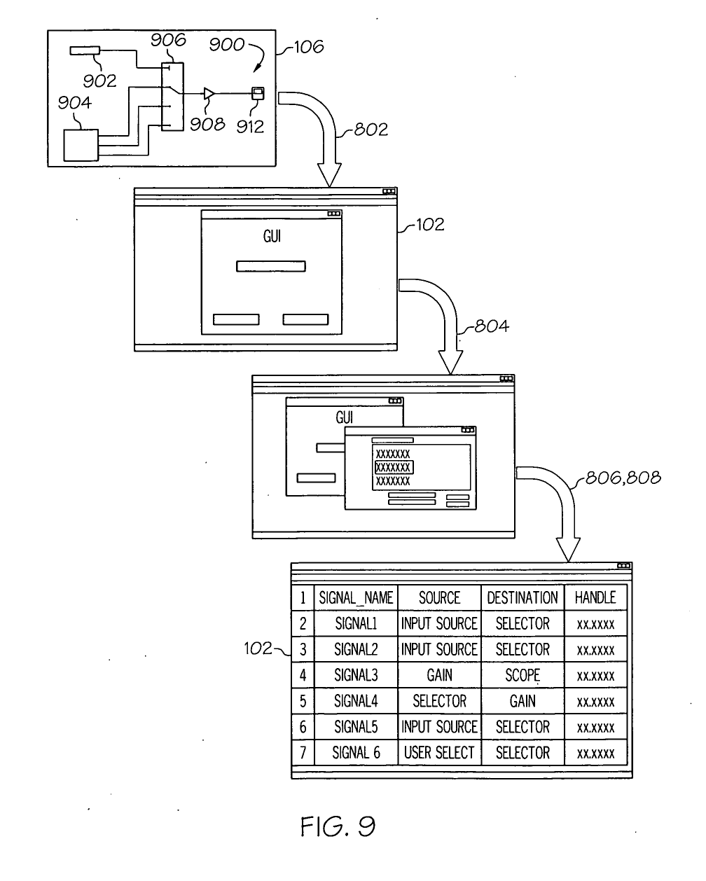

The processing system 104 additionally implements a process to generate a signal list. A task that, as previously noted, is presently performed manually. This process, which is depicted in FIGS. 8 and 9, will now be described. As with the previously described processes 300, 500, the processing system 104, in response to user input to a graphical user interface (GUI) rendered on the display device 102, retrieves the software model 600 from, for example, the memory 106 (802), and parses the descriptive data that defines each component of the software model 900 and its associated signals (804). Before proceeding further, the retrieved software model 900 used to illustrate this process 800 is depicted in FIG. 9. This model 900 is similar to the software model 200 depicted in FIG. 2, but includes fewer components. In particular, the depicted model 900 only includes a user select function 902 and an input source 904, the outputs of which are coupled to separate inputs of a selector 906. The output of the selector 906 is coupled to a gain 908, which is in turn coupled to a scope (or observer) 912. Again, an understanding of the depicted model 900, and of the individual components, devices, and subsystems that comprise the model 900, is not needed and therefore will not be provided.

No matter the specific software model that is retrieved, the processing system 104 uses the parsed descriptive data to categorize each of the signals (806). More specifically, the position of each signal and the blocks associated with each signal may be determined from the descriptive data. Based on these determinations, each signal is categorized as an input signal, an output signal, or an intermediate signal. Thereafter, a signal list is generated that includes each of the categorized signals (808). The generated list may be written to a suitable file for display on the display device 102. The list may be generated in any one of numerous suitable formats, but in the depicted embodiment, as illustrated most clearly in FIG. 9, the list is generated in a spreadsheet format. As FIG. 9 also depicts, the signal list 902 provides a complete description of each signal using the signal name, its source, its destination, and what is referred to in FIG. 9 as its “handle.” The handle of each signal refers various attributes of the signal. The specific attributes may vary, and may include, for example, data type, scaling, rate, etc.

The system and methods described herein reduce the costs with purchasing numerous licenses for proprietary software packages that are used to design models. A duplicate image of a software model is generated in a relatively common format, such as HTML or JPG, and on which system and safety analyses can be readily performed. The described methodology also reduces the time and cost associated with manually creating data flow diagrams and signal lists.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A method of generating an image of a software model that was generated using proprietary, licensed software, the generated software model comprising one or more components defined by descriptive data, the method comprising the steps of:
receiving the generated software model;
parsing the descriptive data representative of each component;
generating a software license independent image of the one or more components using the parsed descriptive data; and
generating a software license independent image of the generated software model using each of the generated software license independent images.

2. The method of claim 1, further comprising:
rendering the software license independent image of the generated software model on a display device.

3. The method of claim 1, wherein the software license independent image of the generated software model is an image selected from the group consisting of an HTML-based image, a JPEG-based image, a PDF-based image.

4. The method of claim 1, further comprising:
generating a library of functional blocks that each define a high-level function, each functional block comprising one or more components with defined connectivity and;
determining if at least selected ones of the components of the generated software model, when grouped together, match one of the functional blocks in the library; and
grouping those components of the generated software model that match the functional blocks into the matched functional block to generate a dataflow diagram.

5. The method of claim 4, further comprising:
rendering, on a display device, a software license independent image of the dataflow diagram.

6. The method of claim 1, further comprising:
automatically generating a signal list using the parsed descriptive data, the signal list including at least a name of each signal in the software generated model, its source, and its destination.

7. The method of claim 6, further comprising:
rendering an image of the generated signal list on a display device.

8. The method of claim 6, wherein the signal list further includes:
a categorization of each signal as an input signal, an output signal, or an intermediate signal; and
an attribute of each signal.

9. The method of claim 6, wherein the generated signal list is in the form of a spreadsheet.

10. A method of generating an image of a data flow diagram for a software model that was generated using proprietary, licensed software, the generated software model comprising one or more components defined by descriptive data, the method comprising the steps of:
generating a library of functional blocks that each define a high-level function, each functional block comprising one or more components with defined connectivity;
receiving the generated software model;
parsing the descriptive data representative of each component to determine interconnections thereof;
determining if at least selected ones of the components of the generated software model, when grouped together, match one the functional blocks in the library;
grouping those components of the generated software model that match the functional blocks into the matched functional block; and
rendering, on a display device, an image of the generated software model using the matched functional blocks and the determined interconnections.

11. The method of claim 10, wherein the software license independent image of the generated software model is an image selected from the group consisting of an HTML-based image, a JPEG-based image, a PDF-based image.

12. The method of claim 10, further comprising:
automatically generating a signal list using the parsed descriptive data, the signal list including at least a name of each signal in the software generated model, its source, and its destination.

13. The method of claim 12, further comprising:
rendering an image of the generated signal list on a display device.

14. The method of claim 12, wherein the signal list further includes:
a categorization of each signal as an input signal, an output signal, or an intermediate signal; and
an attribute of each signal.

15. The method of claim 12, wherein the generated signal list is in the form of a spreadsheet.

16. A system for generating a software license independent image of a software model that was generated using proprietary, licensed software, the generated software model comprising one or more components defined by descriptive data, the system comprising:
a display device; and
a processing system in operable communication with the display device, the processing system configured to selectively import the generated software model and to:
parse the descriptive data representative of each component,
generate data representative of a software license independent image of the one or more components using the parsed descriptive data, and
using the generated data, command the display device to render a software license independent image of the generated software model.

17. The system of claim 16, further comprising:
memory in operable communication with the processing system, the memory having stored therein a library of functional blocks that each define a high-level function, each functional block comprising one or more components with defined connectivity,
wherein the processing system is further configured to:
determine if at least selected ones of the components of the generated software model, when grouped together, match one the functional blocks in the library,
group those components of the generated software model that match the functional blocks into the matched functional block, and
command the display device to render a software license independent image of the generated software model using the matched functional blocks.

18. The system of claim 16, wherein the processing system if further configured to automatically generate a signal list using the parsed descriptive data, the signal list including at least a name of each signal in the software generated model, its source, and its destination.

19. The system of claim 18, wherein the processing system if further configured to command the display device to render an image of the generated signal list.

20. The system of claim 18, wherein:
the generated signal list further includes a categorization of each signal as an input signal, an output signal, or an intermediate signal.
